(19) United States
(12) Patent Application Publication
(10) Pub. No.: US 2006/0128952 A1
(43) Pub. Date: Jun. 15, 2006

(54) Process for the recovery of hemicelluloses from lignocellulosic material

(75) Inventors: Nils Schroder, Bad Fallingbostel (DE); Jurgen Engelhardt, Bad Fallingbostel (DE); Nicole Erasmy, Hamburg (DE); Sascha Lebioda, Escheburg (DE); Bode Saake, Hamburg (DE); Jurgen Puls, Reinbek (DE)

Correspondence Address: BAYER MATERIAL SCIENCE LLC, 100 BAYER ROAD, PITTSBURGH, PA, 15205, US

(73) Assignee: Wolff Cellulosics GmbH & Co. KG

(21) Appl. No.: 11/301,775

(22) Filed: Dec. 13, 2005

(30) Foreign Application Priority Data
Dec. 15, 2004 (DE) 102004060283.2

(51) Int. Cl. C08B 37/00

(52) U.S. Cl. 536/123

(57) ABSTRACT

A process of recovering hemicellulose from lignocellulosic material (e.g., oat husks) is described. The process involves: (a) contacting lignocellulose with an aqueous alkaline solution, thereby forming an alkaline extract; and (b) contacting the alkaline extract with a precipitation bath that includes water and an organic liquid A which is miscible with water, thereby forming a precipitate comprising hemicellulose. In the method of the present invention: (i) the alkaline extract is not neutralised prior to contact with the precipitation bath; and (ii) after completion of precipitation step-(b) the precipitation bath includes organic liquid A in an amount of from 25 wt. % to 70 wt. %, based on the weight of the precipitation bath.

### CROSS REFERENCE TO RELATED PATENT APPLICATION

The present patent application claims the right of priority under 35 U.S.C. § 119 (a)-(d) of German Patent Application No. 102004060283, filed Dec. 15, 2004.

### FIELD OF THE INVENTION

The present invention provides a process for the recovery of hemicelluloses from lignocellulosic material, with high yield and purity.

### BACKGROUND OF THE INVENTION

Many of the secondary products produced during the industrial processing of plants, such as for example wood waste and after-products from the processing of cereals or annual plants for the production of oil, are characterised by a high proportion of carbohydrates which can be extracted with aqueous alkaline media (ref: A. Ebringerova, Das Papier, 12, 1992, 726-733). These materials, known as hemicelluloses, have specific properties, depending on the original plant and the recovery process used, and represent valuable substances for the chemical and foodstuffs industries, and can be used, optionally after chemical modification, as additives in a number of applications, for example as thickeners, binders, flow-improvers, water retention agents or flour substitutes in dough mixtures. Although a number of processes for recovering hemicelluloses from lignocellulosic materials are known, they have not been used hitherto in the commercial field because on the one hand the yields being produced do not meet economic requirements and on the other hand they are costly to operate if the purity required for high-quality applications is to be produced.

U.S. Pat. No. 1,819,233 describes the recovery of pentosans by alternating treatment with hypochlorite solution and sodium hydroxide solution. However, the large number of extraction steps required to produce adequate product quality prevents economic use of this process, which is not very environmentally friendly due to the use of chlorine-containing chemicals.

U.S. Pat. No. 2,709,699 describes a process for recovering hemicelluloses by alkaline extraction followed by precipitation with acid and the addition of ethanol. For a yield of 34.2% of a product which has a relatively high ash content, however, a total of five extraction steps are required which makes industrial implementation costly. The addition of acid prior to precipitation is another disadvantage because it makes recovery of the alkali used impossible.

U.S. Pat. No. 2,868,778 and U.S. Pat. No. 2,801,955 disclose the recovery of hemicelluloses by extraction with calcium hydroxide solution or calcium hydroxide-containing solutions. However, the disadvantage here is that the extract has to be acidified prior to precipitation in order to obtain light-coloured products.

U.S. Pat. No. 4,038,481 discloses a process for recovering hemicelluloses with a very low content of non-carbohydrate components by extraction with an alkaline solution followed by precipitation of the extract in a water-miscible organic liquid. However, in order to increase the yield and improve product quality, the extract also has to be acidified prior to precipitation here, which again makes recovery of the alkali used impossible.

U.S. Pat. No. 5,112,964 describes a process for recovering water-soluble hemicelluloses from cereal parts. In this case, hemicelluloses in the form of a grey powder are obtained in a very low yield of at most 8%, which makes economically viable use very difficult.

DE 44 31 544 describes a process for the isolation of primarily water-soluble ingredients such as proteins and pentosans from rye. The yields then obtained, however, are again only 13% and are thus economically unattractive.

EP 1 155 104 describes a process for recovering arabinoxylan from maize fibres by alkaline extraction. However, the hemicelluloses obtained in good yield by precipitation with alcohol have a dark colour and have a very broad molecular weight distribution, which is a disadvantage for subsequent reactions.

The extraction of xylans from a variety of annual plants, e.g. wheat straw, rice straw, barley straw, maize stalks, oil palm fibres, is described in several publications by the R. C. Sun study group (e.g. R. C. Sun, X.-F. Sun, S.-H. Zhang, J. Agr. Food Chem., 49, 2001, 5122-5129; J. M. Fang, P. Fowler, J. Tomkinson, C. A. S. Hill, Carbohydrate Polymers, 47, 2002, 285-293; R. C. Sun, J. M. Fang, J. Tomkinson, J. Agr. Food Chem., 48, 2000, 1247-1252). In these trials, performed on a laboratory scale and using laboratory methods, the alkaline extract was neutralised with acid each time prior to precipitation. Bleaching was performed in an aqueous system each time, without the addition of organic solvents.

### SUMMARY OF THE INVENTION

However, all these processes disclosed in the prior art, without exception, have the disadvantage that when applied to lignocellulosic materials the hemicelluloses obtained are contaminated to an unacceptable extent with secondary products.

Thus, there is still a need for a process which enables the economic recovery of hemicelluloses from lignocellulosic materials, in high yield and with high purity.

It has now been found that the recovery of hemicelluloses from lignocellulose, in high yield and with high purity, is possible by using a surprisingly simple combination of core process steps in the following sequence:
a) contacting lignocellulose with an aqueous alkaline solution, thereby forming an alkaline extract (referred to herein as the “extraction step” and similar terms);
b) contacting said alkaline extract with a precipitation bath comprising water and an organic liquid A which is miscible (e.g., homogeneously miscible) with water, thereby forming a precipitate comprising hemicellulose (referred to herein as the “precipitation step” and similar terms); and
c) optionally bleaching the isolated hemicelluloses by contact thereof with a bleaching composition that comprises water and organic liquid A (referred to herein as the “bleaching step” and similar terms),
   wherein,
(i) the alkaline extract is not neutralised prior to contact with the precipitation bath, and
(ii) after completion of precipitation step-(b) said precipitation bath comprises organic liquid A in an amount of from 25 wt. % to 70 wt. %, based on the weight of said precipitation bath.

Other than in the examples, or where otherwise indicated, all numbers or expressions, such a those expressing structural dimensions, etc, used in the specification and claims are to be under stood as modified in all instances by the term “about.”

### DETAILED DESCRIPTION OF THE INVENTION

By suitable choice of the composition of the precipitating agent, an unexpectedly high proportion of lignin is removed, while retaining high yields. This means that neutralisation of the extract prior to precipitation is not required, which enables recovery of the alkali used and thus provides a considerable economic advantage as compared with the processes disclosed hitherto.

If extremely high purity is required, the hemicellulose obtained by precipitation can be bleached. If this bleaching step is performed in a bleaching system using a mixture of liquids which has a similar or identical composition to that of the precipitation bath, it can be performed directly after precipitation without the use of other intermediate steps such as e.g. washing. Using this simple, economically advantageous, procedure, unexpectedly good bleaching results can be produced.

The first step a) in the recovery of hemicellulose from lignocellulose according to the invention is an alkaline extraction which is well-known in principle. Here, the lignocellulosic material is extracted with an aqueous alkaline solution. Suitable bases for preparing the alkaline solution are, for example, alkali metal hydroxides such as sodium hydroxide or potassium hydroxide, alkaline earth metal hydroxides such as calcium hydroxide, alkali metal carbonates such as e.g. sodium carbonate, as well as ammonium hydroxide. Alkali metal or alkaline earth metal hydroxides are preferred, particularly preferably sodium hydroxide.

The extraction process may be performed at room temperature, but also at higher temperatures, at atmospheric pressure up to the boiling point of the extraction solution or, in a pressure-tight container, also above the boiling point of the extraction liquid, wherein the duration of treatment and optionally the intensity of mixing are adjusted and depend on the raw material used. The concentration of alkali used also depends on the actual raw material used and is preferably between 0.75 and 2.5 equ/l. The extraction may be performed either in an extraction column, with the lignocellulose being extracted as the stationary phase, or else in a stirred tank.

Any form of lignocellulose may be used as the raw material and it is purified and/or crushed in upstream process steps, depending on the quality of hemicellulose required.

Lignocelluloses are substances which contain both cellulose fibres and lignin. Examples are virtually all structure-providing parts of plants such as wood, cereal shells and husks, stalks of annuals (e.g., cereal straw) and plant fibres (e.g., jute, flax and cotton). Lignocellulosic substances with only small amounts of lignin are especially suitable for the process according to the invention, such as maize stems, wheat straw and in particular oat spelts.

A preferred lignocellulosic raw material is oat spelts, due to its low lignin content and thus the associated relatively easy extractability of the hemicelluloses. Oat spelts, which have been pretreated by roughening their surface using a roller mill, are particularly preferably.

After mechanical separation of the extraction residue, for example by filtering, centrifuging or filter pressing, a hemicellulose-containing extract is obtained. The extract yield can be increased if the extraction residue is subjected to an additional wash process and the loaded wash medium is then added to the extract. The extract may be subjected to further intermediate steps before starting the precipitation process. For example, in connection with recovering the alkali used, the extract may be subjected to a nanofiltration or electrodialysis step, wherein the alkali is abstracted from the extract and therefore actually results in a higher concentration of the dissolved hemicelluloses.

Separation (or isolation) of the hemicelluloses takes place in step b) by introducing the extract into a precipitation medium that includes water and an organic liquid A which is homogeneously miscible with water, wherein the dissolved hemicelluloses precipitate out of solution, while undesired, sometimes strongly coloured, secondary constituents, such as lignin, which are also dissolved during the extraction process, remain in solution. The composition of the precipitation bath is critical with regard to what extent this can be achieved. If the composition of the precipitation bath is chosen appropriately, as shown in the examples given below, the larger part of the undesired secondary constituents are retained in solution while the yield of hemicellulose is hardly reduced at all.

In a preferred composition, the precipitation bath contains between 25 and 75 wt. % of organic liquid A, particularly preferably between 30 and 60 wt. % of organic liquid A, after complete introduction of the extract, based on total weight of the precipitation bath. Organic liquid A is preferably chosen from the group of alcohols or ketones which are homogeneously miscible with water. Examples of suitable alcohols are methanol, ethanol, propanol, isopropanol, butanol as well as glycol and glycerol. Examples of suitable ketones are acetone and methyl ethyl ketone. Methanol, ethanol, isopropanol or acetone are very particularly preferably used.

Although precipitation of the dissolved hemicellulose is also possible in principle by neutralising the extract with acid, as is disclosed in the prior art, this procedure has several disadvantages, which include: (i) precipitation is often incomplete; (ii) the optimum purification effect is not realized; and/or (iii) the alkali used for extraction is neutralised by the addition of acid, and as such is no longer available for recovery.

In the event of a composition for the precipitation bath in accordance with the invention, neutralisation of the extract is not required. The alkali used remains in dissolved form in the precipitation bath and can be recovered from this in a downstream workup process.

Mechanical separation of the precipitated hemicellulose can be performed using a variety of processes that include, for example, filtering, centrifuging or filter pressing.

If a particularly high degree of purity or particularly low discolouration of the hemicellulose is desired, the process according to the invention offers the possibility of appending a bleaching stage in an additional step c), without further intermediate steps. For this purpose, the separated hemicellulose is preferably treated with a mixture of liquids which contains the same components as the precipitation bath, i.e. water and an organic liquid A which is miscible with water.

Suitable bleaching agents include, for example, chlorine, hypochlorite, chlorine dioxide, oxygen, peroxo compounds, potassium permanganate or ozone, preferably hydrogen peroxide or ozone. Typical concentrations of bleaching agent are, for example, in the case of hydrogen peroxide, 1 to 10 wt. %, with respect to the solid being bleached, in the case of ozone 0.01 to 1 wt. %, with respect to the weight of the material being bleached. Furthermore, conventional auxiliary agents, such as sodium hydroxide, may be used.

This procedure offers the advantage that the medium does not have to be changed and thus no additional material components are introduced. The bleaching system is particularly preferably adjusted in such a way that its composition, with regard to the components water and organic liquid A, corresponds to that of the precipitation bath once the extract has been completely introduced.

In the method of the present invention, the bleaching step involves contacting the hemicellulose with a bleaching composition comprising water and organic liquid A. More particularly, the bleaching composition comprises organic liquid A in an amount of from 25 wt. % to 70 wt. %, based on the weight of the bleaching composition (in the absence of bleaching agents, such as hydrogen peroxide).

This procedure offers the advantage of an additional purification effect, in addition to simplified storage.

The invention is explained in more detail in the following by the use of examples which are not intended to restrict the disclosure according to the invention. Further working examples are obvious to a person skilled in the art, in the context of the disclosure according to the invention.

### EXAMPLES

### Example 1

Oat spelts are extracted with 5% strength sodium hydroxide solution for 60 minutes at 90° C., at a solids content of 10%. The extract obtained by pressing, filtering or centrifuging is then subjected to precipitation in differently composed methanol/water mixtures. Here, 200 g of extract are introduced each time to 600 g of precipitation bath. Yields and kappa indices for the hemicelluloses obtained by pressing, filtering or centrifuging are given in Table 1.

The kappa number gives the amount in ml of 0.1 N potassium permanganate solution which is consumed during the treatment of 1 g of dry test substance. The kappa number gives an indication of the degree of decomposition of celluloses and cellulose-like substances (e.g., hemicelluloses), in particular it gives an indication of the residual lignin content. The smaller the kappa number, the smaller is the concentration of fractions which can be oxidised with KMnO₄ (substantially lignin). The kappa number is well-known to a person skilled in the art and is a conventional method for characterising celluloses; it is determined, for example, in accordance with Zellcheming Merkblatt IV/37/80.

TABLE 1
Yields and kappa number of hemicelluloses obtained by
precipitation of an alkaline oat spelt extract in methanol/water mixtures.

| c MeOH | Overall yield | KH yield | Kappa |
|---|---|---|---|
| 75 | 13.8 | 10.0 | 61.9 |
| 60 | 12.1 | 9.9 | 45.8 |
| 52.5 | 11.8 | 9.8 | 44.2 |
| 45 | 10.8 | 9.6 | 34.2 |
| 41.3 | 11.5 | 9.5 | 42.9 |

c MeOH - Concentration of methanol in the precipitation bath after complete introduction of the extract (% w/w)
Overall yield - Absolute yield of precipitated material (g/200 g of extract)
KH yield - Absolute yield of carbohydrates and hemicelluloses (g/200 g extract)
Kappa - Kappa number of the hemicellulose, a measure of the lignin fraction

The data show that, given an almost constant carbohydrate yield, the overall yield passes through a minimum at about 45% methanol with a decreasing proportion of methanol in the precipitation bath. Accordingly, at this point the removal of impurities is at a maximum, which is confirmed by the kappa number.

### Example 2

Oat spelts are extracted with 5% strength sodium hydroxide solution for 60 minutes at 90° C., using a solids density of 10%. The extract obtained by pressing, filtering or centrifuging is then neutralised with conc. sulfuric acid and afterwards subjected to precipitation in differently composed methanol/water mixtures. Here, 200 g of extract are introduced each time to 600 g of precipitation bath. Yields and kappa number for the hemicelluloses obtained by pressing, filtering or centrifuging are given in Table 2.

TABLE 2
Yields and kappa number of hemicelluloses obtained by
precipitation of a neutralised oat spelt extract in methanol/water
mixtures.

| c MeOH | Overall yield | KH yield | Kappa |
|---|---|---|---|
| 75 | 12.4 | 9.9 | 56.6 |
| 60 | 11.5 | 9.9 | 53.0 |
| 45 | 11.4 | 9.6 | 61.7 |
| 30 | 10.4 | 8.0 | nd |

nd—cannot be determined

The data show that upstream neutralisation of the extract leads to hemicelluloses whose lignin content, in the region of the overall yield minimum, is clearly higher than is the case for hemicelluloses which have been precipitated without upstream neutralisation, in accordance with example 1. Upstream neutralisation thus leads not only to loss of the alkali used, but also to products with lower purity.

### Example 3

Oat spelts are extracted with 5% strength sodium hydroxide solution for 60 minutes at 90° C., using a solids density of 10%. The extract obtained by pressing, filtering or centrifuging is then subjected to precipitation in differently composed isopropanol/water mixtures. Here, 200 g of extract are introduced each time to 600 g of precipitation bath. Yields and kappa indices for the hemicelluloses obtained by pressing, filtering or centrifuging are given in Table 3.

TABLE 3
Yields and kappa number of hemicelluloses obtained by
precipitation of an alkaline oat spelt extract in isopropanol/water mixtures.

| c IPA | Overall yield | KH yield | Kappa |
|---|---|---|---|
| 75.0 | 20.7 | — | — |
| 60.0 | 14.4 | 6.9 | 107.2 |
| 51.3 | 10.4 | 6.9 | 49.7 |
| 45.0 | 10.5 | 6.9 | 53.1 |
| 41.3 | 9.1 | 6.5 | 36.3 |
| 37.5 | 8.3 | 5.4 | 39.6 |
| 30.0 | 8.7 | 5.6 | 41.8 |

c IPA - Concentration of isopropanol in the precipitation bath after complete introduction of the extract (%)

The data demonstrate that when using isopropanol as a precipitation medium the overall yield increases a great deal more than the carbohydrate yield as from a concentration of about 50% of isopropanol in the precipitation bath, so the product, as can also be seen from the kappa number, becomes more and more contaminated with increasing concentration of isopropanol in the precipitation bath.

### Example 4

Precipitated hemicellulose from example 2 (amount of MeOH in the precipitation bath: 60% w/w) is treated for 120 min at 90° C. in methanol/water mixtures of various compositions with the addition of 4% sodium hydroxide solution and 6% hydrogen peroxide (each with respect to absolutely dry crude xylan) at a substance density of 10%. The kappa number and Brightness of the bleached hemicelluloses obtained by pressing, filtering or centrifuging are given in Table 4.

TABLE 4
Brightness and kappa number of hemicelluloses obtained after
peroxide bleaching in methanol/water mixtures

| c MeOH | Brightness | Kappa |
|---|---|---|
| 100 | 70.8 | 36.9 |
| 80 | 74.8 | 29.9 |
| 70 | 77.6 | 25.4 |
| 60 | 80.5 | 24.2 |
| 50 | 78.7 | 22.2 |
| 40 | 72.1 | 25.7 |
| 30 | 60.9 | 26.6 |
| 20 | 42.4 | 29.5 |

c MeOH - Concentration of methanol in the bleaching slurry (% w/w)
Brightness—Brightness (% ISO)

The best bleaching results are produced with a 50 to 60% methanol concentration in the bleaching slurry and thus also within the region of the optimum composition for precipitation.

### Example 5

Precipitated hemicellulose from example 3 (amount of IPA in the precipitation bath: 40% w/w) is treated for 120 min at 90° C. in isopropanol/water mixtures of various concentrations with the addition of 0.9% caustic soda solution and 4% hydrogen peroxide (each with respect to absolutely dry crude xylan) at a substance density of 10%. The kappa number and Brightness of the bleached hemicelluloses obtained by pressing, filtering or centrifuging are given in Table 5.

TABLE 5
Brightness and kappa number of hemicelluloses obtained after
peroxide bleaching in isopropanol/water mixtures

| c IPA | Brightness | Kappa |
|---|---|---|
| 55 | 84.9 | 14.0 |
| 50 | 84.0 | 13.1 |
| 40 | 88.6 | 12.2 |
| 35 | 87.0 | 12.2 |
| 30 | 62.6 | 16.7 |
| 20 | 48.4 | 18.4 |

c IPA - Concentration of isopropanol in the bleaching slurry (% w/w)
Brightness—Brightness (% ISO)

The best bleaching results are produced with a 40% isopropanol concentration in the bleaching slurry and thus also within the region of the optimum composition for precipitation.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the recovery of hemicelluloses from lignocellulosic material, comprising:
a) contacting lignocellulose with an aqueous alkaline solution, thereby forming an alkaline extract; and
b) contacting said alkaline extract with a precipitation bath comprising water and an organic liquid A which is miscible with water, thereby forming a precipitate comprising hemicellulose,
wherein,
(i) the alkaline extract is not neutralised prior to contact with the precipitation bath, and
(ii) after completion of step-(b) said precipitation bath comprises organic liquid A in an amount of from 25 wt. % to 70 wt. %, based on the weight of said precipitation bath.

2. The process of claim 1 wherein after completion of step-(b) said precipitation bath comprises organic liquid A in an amount of from 30 wt. % to 60 wt. %, based on the weight of said precipitation bath.

3. The process of claim 1 wherein organic liquid A is selected from the group consisting of alcohols, ketones and combinations thereof.

4. The process of claim 3 wherein organic liquid A is selected from the group consisting of methanol, ethanol, isopropanol, acetone and combinations thereof.

5. The process of claim 1 wherein said aqueous alkaline solution comprises an alkali material selected from the group consisting of alkali metal hydroxide, alkaline earth metal hydroxide and combinations thereof.

6. The process of claim 1 further comprising bleaching the hemicellulose of step-(b).

7. The process of claim 6 wherein the bleaching step comprises contacting the hemicellulose with a bleaching composition comprising water and organic liquid A.

8. The process of claim 7 wherein said bleaching composition comprises organic liquid A in an amount of from 25 wt. % to 70 wt. %, based on the weight of said bleaching composition.

9. The process of claim 1 wherein the lignocellulose is oat spelts.

10. A hemicellulose prepared by the process of claim 1.
